(19) United States
(12) Patent Application Publication
(10) Pub. No.: US 2008/0285866 A1
(43) Pub. Date: Nov. 20, 2008

(54) APPARATUS AND METHOD FOR IMAGE DATA COMPRESSION

(76) Inventor: Takashi Ishikawa, Hachioji-shi (JP)

Correspondence Address: OSTROLENK FABER GERB & SOFFEN, 1180 AVENUE OF THE AMERICAS, NEW YORK, NY, 100368403, US

(21) Appl. No.: 12/113,548

(22) Filed: May 1, 2008

(30) Foreign Application Priority Data
May 16, 2007 (JP) 2007-130262
Feb. 29, 2008 (JP) 2008-049599

(51) Int. Cl. G06K 9/36

(52) U.S. Cl. 382/232

(57) ABSTRACT

Storage of JPEG data is speeded up by providing a RAW compression processing section for detecting high frequency components of image data, a JPEG parameter setting section for calculating feature data (entropy) representing distribution of frequency of appearance of the high frequency components, a JPEG parameter setting section for calculating, based on the feature data, predictive coding amount when the image data has been compressed on the basis of a first quantization table, a JPEG parameter setting section, for calculating a second quantization table for obtaining a target code amount that is desired to be finally obtained in the RAW compression processing section 57, based on the target code amount and the predictive coding amount, and a JPEG processing section for carrying out JPEG compression processing based on the second quantization table.

Benefit is claimed, under 35 U.S.C. §119, to the filing date of prior Japanese Patent Applications No. 2007-130262, filed on May 16, 2007, and No. 2008-049599, filed on Feb. 29, 2008. These applications are expressly incorporated herein by reference. The scope of the present invention is not limited to any requirements of the specific embodiments described in the application.

### BACKGROUND OF THE INVENTION

1. Field of the Invention

The present invention relates to an image data compression device, and to an image data compression method and program.

2. Description of the Related Art

In some imaging devices, such as single lens reflex digital cameras, an exposure mode is provided where it is possible to store RAW image data that has been subjected to lossless compression and JPEG data that has been subjected to lossy compression, at the same time. In storing image data in this exposure mode, it is necessary to carry out JPEG encoding processing together with RAW data compression processing. In a system that takes some time to perform JPEG encoding processing, the possibility of this JPEG processing time constituting a bottleneck to the storage time is high. Also, in order to make the JPEG encoding amount a constant amount or less without lowering quality, it is necessary to carry out the encoding processing a number of times, and for these reasons there is a problem that a long processing time is required until storage.

Therefore, in order to resolve the issue of the processing time required when RAW image data and JPEG data are stored at the same time, there has been proposed, in Japanese unexamined patent application No. 2006-229474 (laid-open Aug. 31, 2006) an imaging device that reduces the number of iterations of JPEG processing by sharing a JPEG image contained in a JPEG file and RAW data.

### SUMMARY OF THE INVENTION

The present invention has been conceived in view of the above described situation, and provides an image data compression device, an image data compression method and a program, that increase the speed of storing JPEG data.

An image data compression device of the present invention comprises a RAW compression processing section for subjecting image data to lossless compression and obtaining compression information relating to the image compression, a lossy compression processing section for subjecting image data to lossy compression, and a parameter calculating section for obtaining a parameter for giving a target data size based on the compression information, wherein the lossy compression processing section performs lossy compression based on the parameter.

### BRIEF DESCRIPTION OF THE DRAWINGS

FIG. 1 is a block diagram showing the electrical structure of a digital single lens reflex camera relating to one embodiment of the present invention.

FIG. 2 is a block diagram relating to compression processing inside an ASIC relating to one embodiment of the present invention.

FIG. 3 is a diagram showing the flow of image compression processing relating to one embodiment of the present invention.

FIG. 4 is a diagram showing the flow of RAW compression relating to one embodiment of the present invention.

FIG. 5 is a diagram showing the flow of RAW compression processing relating to one embodiment of the present invention.

FIG. 6 is a diagram showing the flow of JPEG parameter setting relating to one embodiment of the present invention.

FIG. 7 is a diagram showing the flow of quantization parameter calculation relating to one embodiment of the present invention.

FIG. 8 is a diagram showing the flow for a Huffman table relating to one embodiment of the present invention.

FIG. 9 is a diagram showing the flow of image processing relating to one embodiment of the present invention.

FIG. 10 is a diagram showing the flow of JPEG processing relating to one embodiment of the present invention.

FIG. 11 is a diagram showing correlation of entropy and JPEG code size relating to one embodiment of the present invention.

FIG. 12 is a diagram showing correlation of entropy and JPEG code size relating to one embodiment of the present invention.

FIG. 13 is a diagram showing correlation of a JPEG quantization table and JPEG code size relating to one embodiment of the present invention.

FIG. 14 is a diagram showing a Huffman table relating to one embodiment of the present invention.

### DETAILED DESCRIPTION OF THE PREFERRED EMBODIMENTS

In the following, one preferred embodiment using a digital single lens reflex camera adopting the present invention will be described using the drawings. A digital single lens reflex camera relating to this embodiment carries out various image processing on image data and then stores the results in an image storage medium, once the composition of a subject has been determined and the subject image taken. Also, as an image storage mode, an exposure mode is selectable that performs lossy compression processing using JPEG and lossless compression processing using RAW, and stores image data resulting from compression processing of both the lossy compression and the lossless compression.

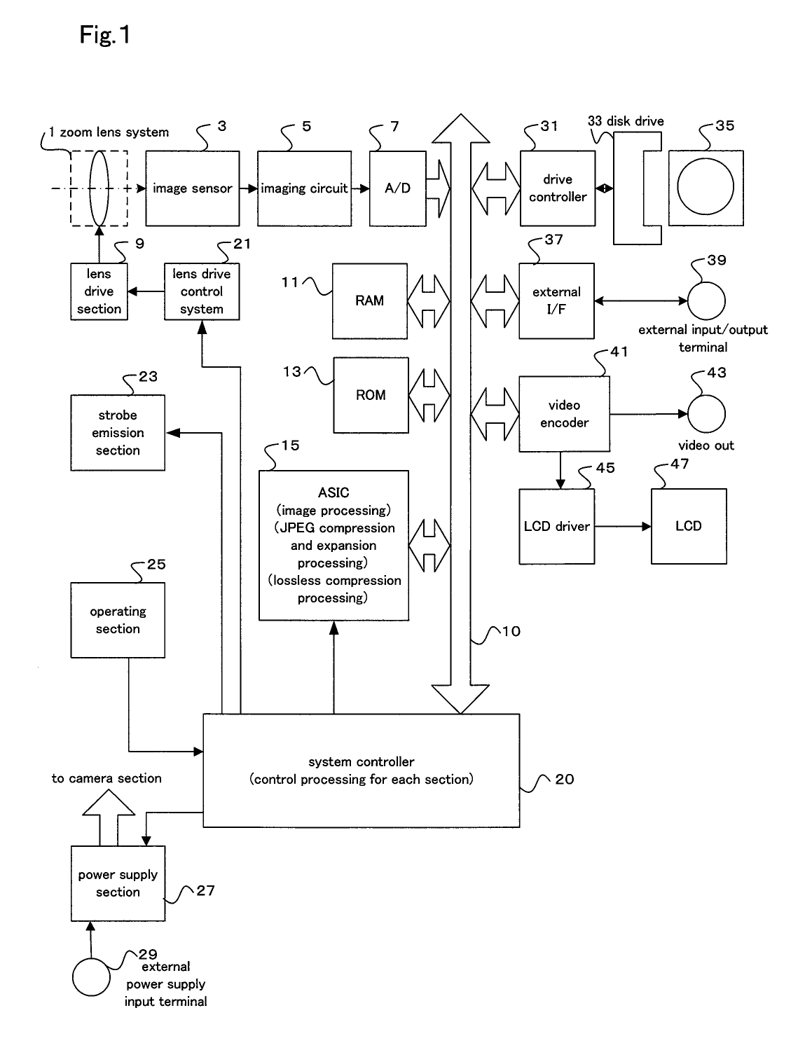

The electrical structure of the digital single lens reflex camera of this embodiment will be described using FIG. 1. A zoom lens system 1 for capturing the subject image is fitted to a camera body. The focusing length of this zoom lens system 1 is variable, and drive for adjusting the focal length and the focus position of the zoom lens system 1 is carried out using a lens drive section 9 provided with a motor etc.

An image sensor 3 is arranged on the optical axis of the zoom lens system 1, close to the position where the subject image is formed. This image sensor 3 photoelectrically converts the subject image and outputs an image signal. Output of the image sensor 3 is connected to an imaging circuit 5 for performing signal processing such as readout of the image signal and amplification processing, and output of this imaging circuit 5 is connected to an analog to digital (A/D) converter 7 that performs AD conversion of the image signal.

The A/D converter 7 is connected to a data bus 10, and a RAM (Random Access Memory) 11, ROM (Read Only Memory) 13, ASIC (Application Specific Integrated Circuit) 15, system controller 20, drive controller 31, external I/F (interface) 37 and video encoder 41 are respectively connected to the data bus 10.

The RAM 11 is an electrically rewritable memory, and performs temporary storage of data. The ROM 13 is an electrically rewritable non-volatile memory, and stores programs and various adjustment values etc. for carrying out control of the digital single lens reflex camera.

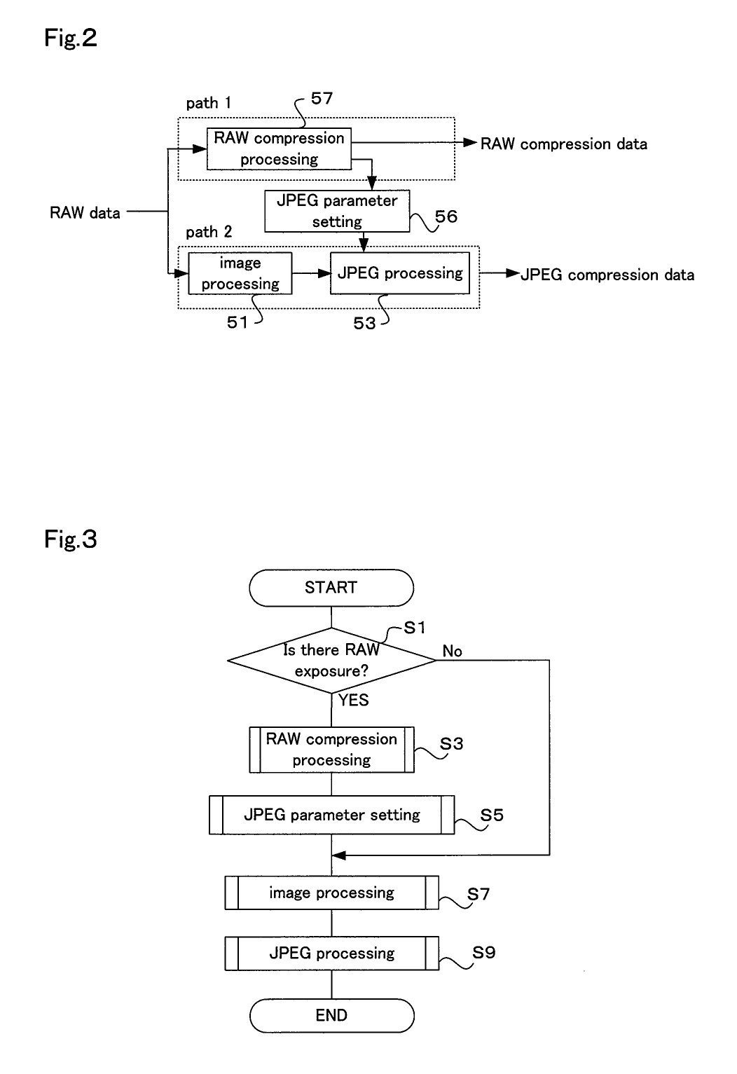

The ASIC 15 is hardware for carrying out various processing such as image processing, JPEG compression and expansion processing, RAW compression and expansion processing etc., and is connected to the system controller 20. Operation for compression processing by the ASIC 15 will be described later using FIG. 2. The system controller 20 is constituted by a CPU (Central Processing unit) for example, and performs overall control of the digital single lens reflex camera in accordance with programs stored in the ROM 13.

The system controller 20 is connected to a lens drive control circuit 21, a strobe emission section 23, an operating section 25 and a power supply section 27, and performs control of these circuits etc. The lens drive control circuit 21 performs drive control for the lens drive section 9, and performs focal length and focusing operations of the zoom lens system 1. The strobe emission section 23 projects illuminating light towards the subject in accordance with control signals from the system controller 20.

The operating section 25 includes switches connecting to various operating sections, such as a power supply switch, a first release switch and a second release switch linked to a release button, an exposure mode switch, a menu switch, and an arrow key for allowing operation of a cursor etc., and various settings by the photographer and a release operation are detected.

The power supply section 27 supplies power required for operation of the digital single lens reflex camera, and includes a power supply battery and a voltage control circuit. Also, an external power supply input terminal 29 is provided in the power supply section 27 in order to receive supply of external power from a commercial power supply or a battery pack etc.

A drive controller 31 is connected to the data bus 10, and a disk drive 33 is connected to this drive controller 31. A storage medium 35 can be loaded into the disk drive 33. This storage medium 35 is a medium for storing image data that has been subjected to image processing by the ASIC 15 etc., and storage control of the disk driver 33 is carried out by the drive controller 31.

An external interface 37 is connected to the data bus 10, and this external interface 37 is connected to an external input/output terminal 39. The external interface 37 is an interface for performing interchange of image data and other data with an external device such as a personal computer (PC).

A video encoder 41 is also connected to the data bus 10, and video out 43 and an LCD (Liquid Crystal Display) driver 45 are connected to this video encoder 41. This video encoder 41 is a converter for converting to image data for display etc. based on image data stored in the RAM 11 or the storage medium 35. The image data converted here is externally output via the video out 43, and displayed on an LCD 47 using the LCD driver 45.

An LCD 47 is located on the rear surface of the digital single lens reflex camera, and performs display of a subject image stored in the RAM 11 or storage medium 35, as well as display of the various exposure mode and control values that have been set using the operating section 25.

Next, RAW compression and JPEG compression that take place inside the ASIC 15 will be described using FIG. 2. Image signals output from the image sensor 3 are converted to digital format RAW data (image data) by the A/D converter 7, and input via the data bus 10 to the ASIC 15. The block for compression shown in FIG. 2 is comprised of a path 1 for carrying out RAW compression processing and a path 2 for carrying out JPEG compression processing.

The RAW data input section is connected to the image processing section 51 constituting the path 2, and output of the image processing section 51 is connected to a JPEG processing section 53. Also, the RAW data input section is also connected to a RAW compression processing section 57 constituting the path 1, and output of the RAW compression processing section 57 is connected to a JPEG parameter setting section 56.

Output of the JPEG parameter setting section 56 is connected to the JPEG processing section 53. The image processing section 51, JPEG processing section 53, JPEG parameter setting section 56 and RAW compression processing section 57 are constituted by hardware circuits.

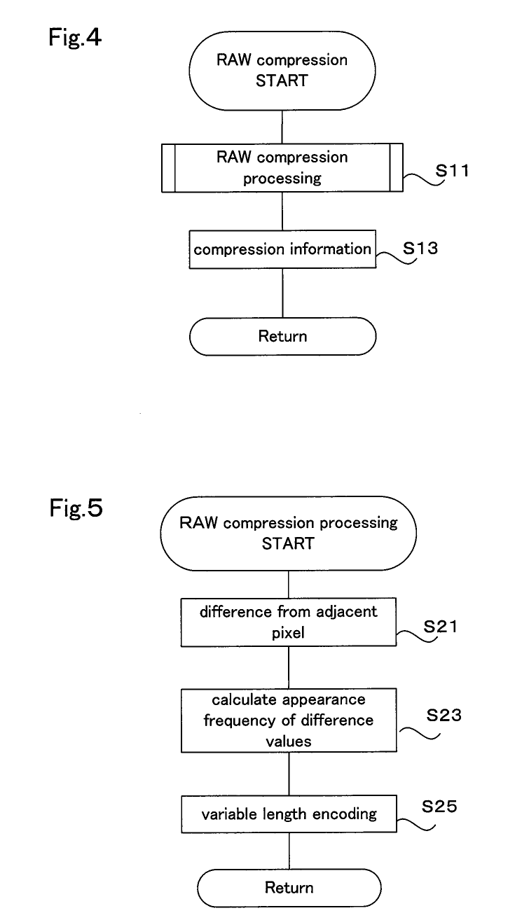

The RAW compression processing section 57 of path 1 subjects input RAW image data to lossless compression, and obtains difference values between adjacent pixels at the time of compression, and in this way calculates feature data representing distribution of appearance frequency of difference values. Detailed operation of the RAW compression processing section 57 will be described later using FIG. 4 and FIG. 5.

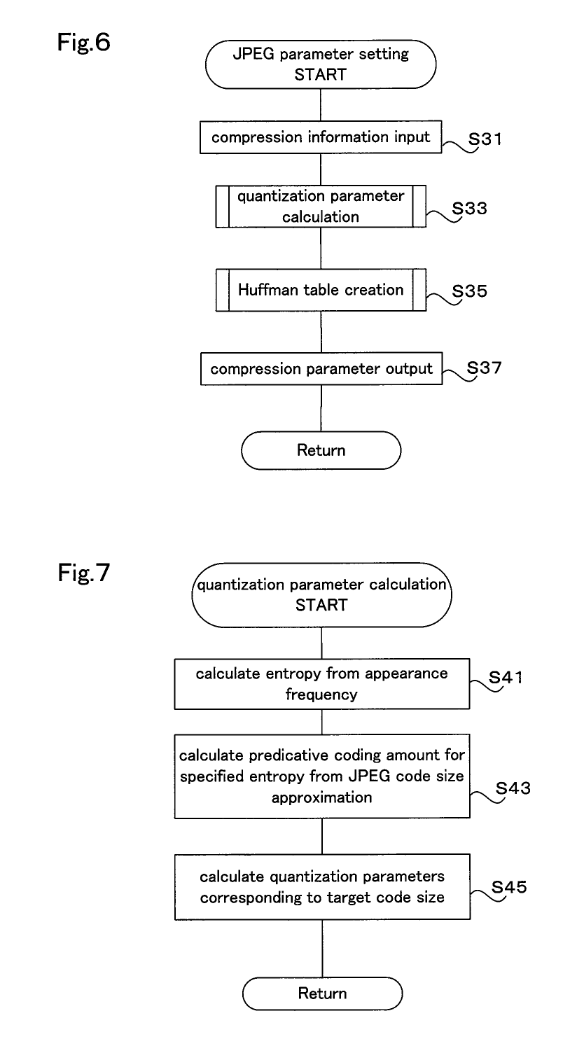

RAW compression data is output from an output terminal of the RAW compression processing section 57, and the previously described feature data is output to the JPEG parameter setting section 56. The JPEG parameter setting section sets a JPEG parameter using the feature data, and outputs the JPEG parameter to the JPEG processing section 53. Detailed operation of the JPEG parameter setting section 56 will be described later using FIG. 6 to FIG. 8.

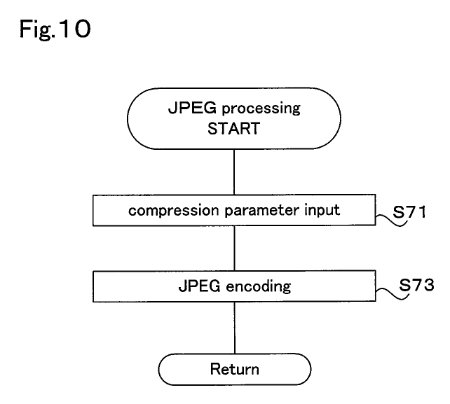

The image processing section 51 of path 2 performs correction such as white balance and image processing such as YC conversion for input RAW image data. Detailed operation of the image processing section 51 will be described later using FIG. 9. The JPEG processing section 53 is a circuit for subjecting image data to lossy compression processing using the JPEG format, and at the time of performing JPEG compression performs compression using compression parameters output from the JPEG parameter setting section 56. Detailed operation of the JPEG processing section 53 will be described later using FIG. 10.

RAW compression data is output from the above described RAW compression processing section 57 of path 1, and JPEG compression data is output from the JPEG processing section 53 of path 2. Specifically, using the circuit shown in FIG. 2, RAW data based on output of the image sensor 3 is subjected to lossy compression and output as JPEG compression data, and subjected to lossless compression and output as RAW compression data.

Next, operation of the circuit for carrying out the compression processing inside the ASIC 15 shown in FIG. 2 will be described using FIG. 3 to FIG. 10. FIG. 3 shows overall operation of compression processing, with this processing flow being controlled by the system controller 20, and individual processes being executed by individual circuit blocks within the ASIC 15.

If the processing for image compression shown in FIG. 3 is started, it is determined whether or not there is RAW exposure (S1). With the digital single lens reflex camera relating to this embodiment image data of a taken image is stored in the storage medium 35 after having been subjected to JPEG compression, but it is possible to also store together with RAW compression data by the photographer operating the menu mode etc. In step S1, detection of whether or not there has been exposure mode setting for carrying out storage of this RAW compression data simultaneously is carried out.

If the result of this detection in step S1 is that there is RAW exposure mode, RAW compression processing is carried out in the RAW compression processing section 57 (S3). At the time of RAW compression processing in this step, difference values for image data between adjacent pixels are obtained, and from the difference values compression information (frequency of appearance of difference values) is output. Operation of this RAW compression processing will be described later using FIG. 4 and FIG. 5.

If RAW compression processing is completed, JPEG parameter setting is then carried out (S5). In this JPEG parameter setting, quantization parameters are calculated based on compression information obtained in the RAW compression processing, a Huffman table is created, and compression parameters are output. The JPEG parameter setting will be described later using FIG. 6 to FIG. 8.

If the JPEG parameter setting of step S5 is completed, or if the result of determination in step S1 was that RAW exposure has not been carried out, image processing is then carried out (S7). In this step, processing such as correction processing, such as white balance, and, since the pixel arrangement is a Bayer array, interpolation processing of each of RGB pixel outputs at respective pixel positions, and YC conversion etc. is carried out. This image processing will be described later using FIG. 9.

If the image processing of step S7 is completed, JPEG processing is then carried out (S9). The JPEG processing performs JPEG encoding using compression parameters set in step S5. Operation of the JPEG processing will be described later using FIG. 10.

Next, operation of the RAW compression processing of step S3 will be described using the flow shown in FIG. 4. If the flow shown in FIG. 4 is entered, RAW compression processing is carried out (S11). This RAW compression processing executes the steps shown in FIG. 5. Differences between adjacent pixels in the overall image are first obtained using RAW data (S21). These difference values correspond to high frequency components of the image. Next, appearance frequency of the obtained difference values is calculated (S23).

Then, variable length coding is carried out based on the difference values obtained in step S21 (S25). Specifically, entropy coding is carried out, but in this embodiment variable length coding based on Huffman code is carried out.

RAW compression data is generated by the variable length coding of step S25. Returning to FIG. 4, compression information is generated, and this compression information is output to the JPEG parameter setting section 56 (S13). In this embodiment, appearance frequency of difference values calculated in step S23 is output as compression information.

Next, returning to FIG. 3, the JPEG parameter setting of step S5 will be described using FIG. 6. This JPEG parameter setting is executed in the JPEG parameter setting section 56. First the compression information is input (S31). This information is information output in step S13 at the time of RAW compression, specifically, appearance frequency of the difference values, as described above.

If the compression information is input, calculation of quantization parameters is carried out based on this compression information (S33). The flow of this quantization parameter calculation is shown in FIG. 7. As shown in the flow of FIG. 7, first of all entropy (feature data) is calculated from the size of high frequency components, that is, from the difference values of image data between adjacent pixels, and the appearance frequencies of these difference values (S41).

Specifically, here, when a parameter representing size of a high frequency component is made i, and appearance frequency corresponding to this parameter i is made Pi, entropy is calculated from

ΣPi·Log Pi (equation 1)

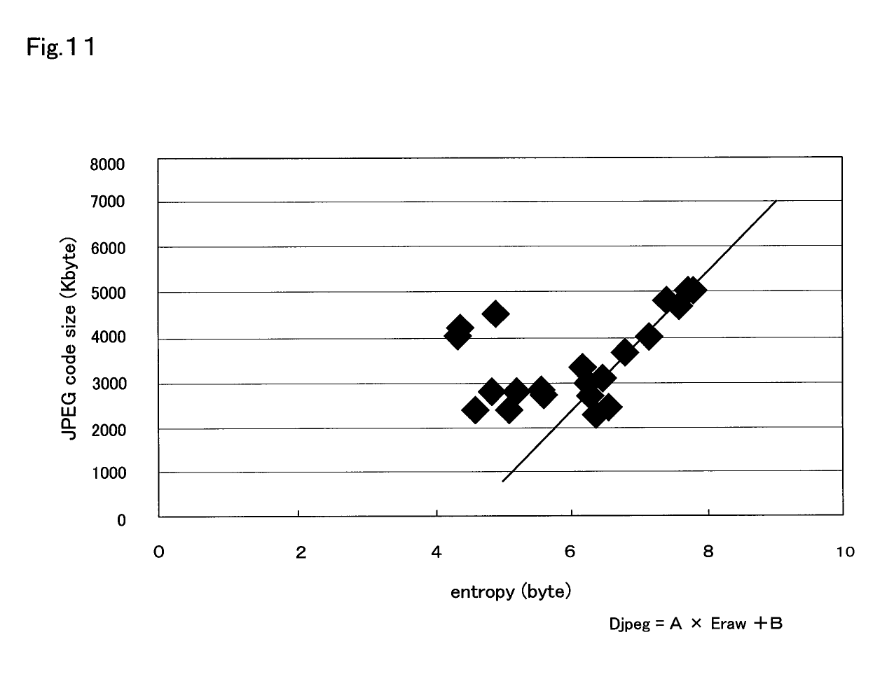

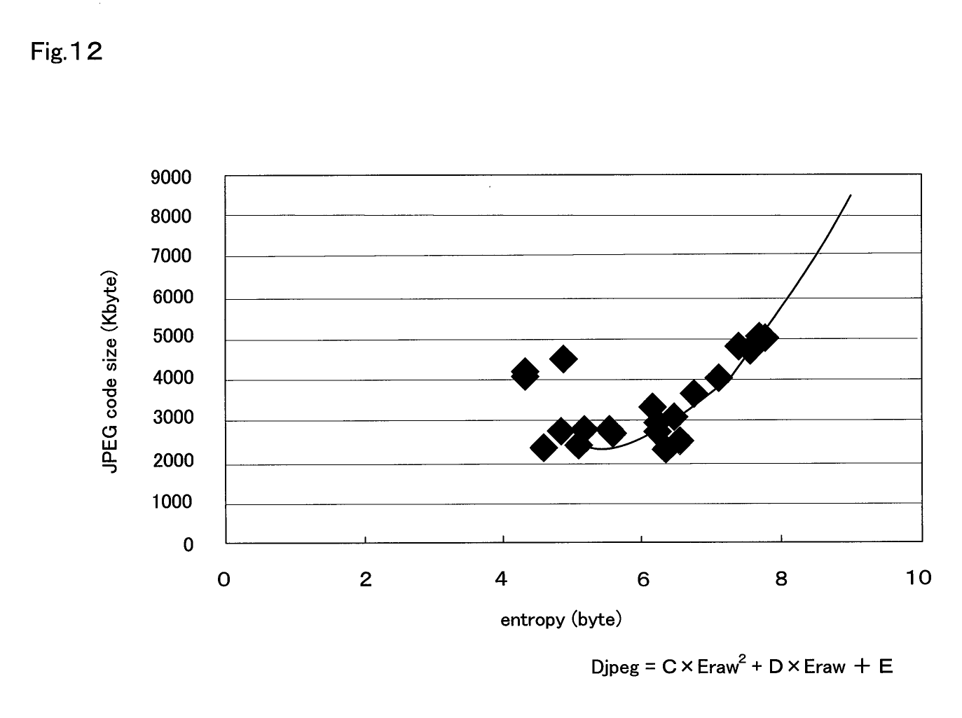

Next, calculation of predictive coding amount for specified entropy is calculated from a JPEG code size approximation (S43). Specifically, entropy and JPEG code size have a fixed correlation as shown in FIG. 11 and FIG. 12. The graphs of FIG. 11 and FIG. 12 are experimental data created based on image data.

If this correlation shown in FIG. 11 is approximated as a linear equation, equation (2) is derived.

Djpeg=A×Eraw+B (equation 2)

### Here,

Eraw is entropy of RAW data

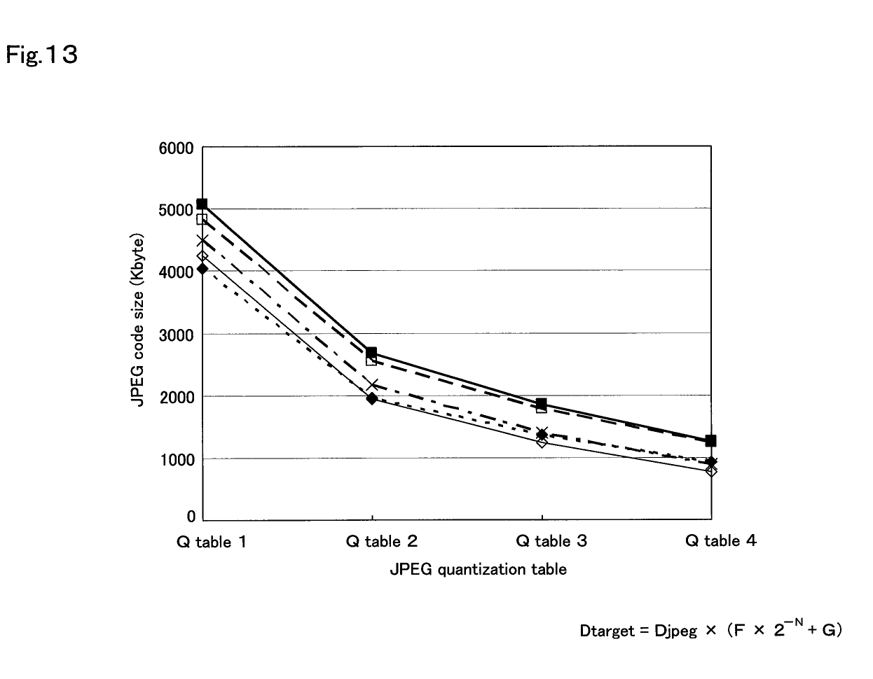

Djpeg is predictive code amount with quantization table 1 (refer to Q table 1 in FIG. 13), and

A, B are constants.

Also, if a relationship between entropy and JPEG code size is approximated to a quadratic equation, as shown in FIG. 12, equation 3 is derived:

Djpeg=C×Eraw²+D×Eraw+E (Equation 3)

C, D and E are constants.

If predictive coding amount corresponding to entropy of image data is calculated in step S43 using the approximations such as equation 2 and equation 3, then calculation of quantization parameters corresponding to a target code size is carried out (S45).

Compression of the JPEG format involves dividing an image into blocks, converting from space domains to frequency domains by Discrete Cosine Transform in block units, and reducing information amount by quantizing this converted data, and finally performing entropy encoding using Huffman code. In this embodiment therefore, by selecting quantization parameters for the quantizing stage a target data size is achieved.

A quantization table (Q table) is simply putting divisors, for quantizing by division of each DCT (Discrete Cosine Transform) coefficient obtained by discrete Cosine Transform in block units, as is well known, by a specified value, in the form of a table.

When the values of the Q table 1 of FIG. 13 are made Q1 (Q1 is a set of a plurality of values), and quantization is carried out by setting a value of N arbitrarily so that values of the Q table becomes

Q1×2^{-N} (equation 4)

to generate an arbitrary quantization table, this integer N is a quantization parameter.

There is a fixed correlation as shown in FIG. 13 between JPEG code size and the quantization table. The Q tables Q1 to Q4 of FIG. 13 respectively correspond to quantization parameters N1, N2, N3 and N4.

If this correlation is represented as an approximation, equation 5 results:

Dtarget=Djpeg×(F×2^{-N}+G) (equation 5)

### Where:

Dtarget=target code amount

Djpeg=predictive JPEG code amount with quantization table 1 (Q table 1)

N is a quantization parameter, and

F and G are constants.

Using the approximations above, a quantization parameter that will give the target JPEG code size (predictive code amount) is calculated. The graph shown in FIG. 13 is experimental data created based on image data, and the four lines are JPEG code sizes obtained by substituting respective quantization tables (or quantization parameters) for four types of image. It will be understood that the values being different depending on the image has a fixed correlation.

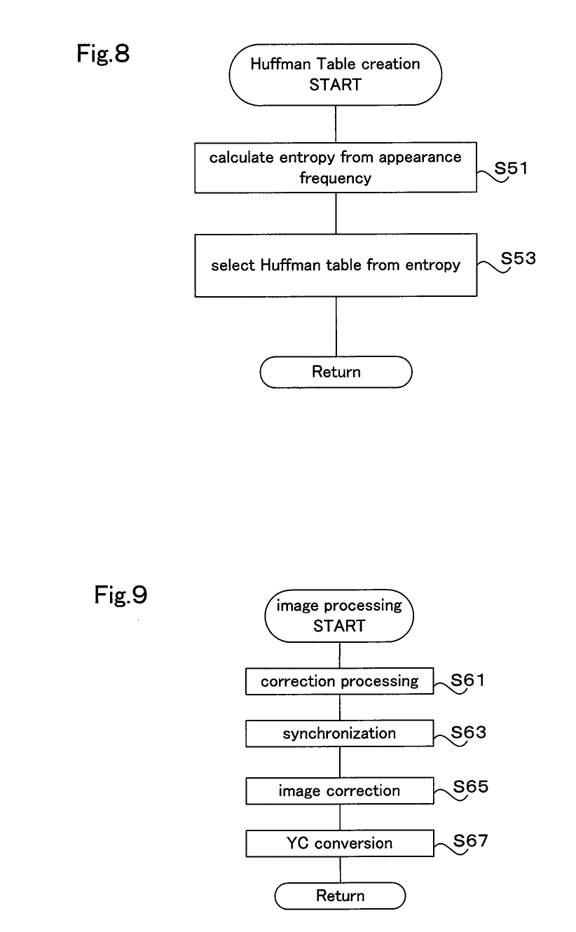

If the quantization parameter is calculated in step S45, then returning to FIG. 6 creation of a Huffman table is carried out (S35 in FIG. 6). The flow of this Huffman table creation is shown in FIG. 8. First, calculation of entropy from the appearance frequency is carried out (51). This entropy calculation is similar to step S41, and is carried out based on equation 1, but the result obtained in step S41 is used as it is.

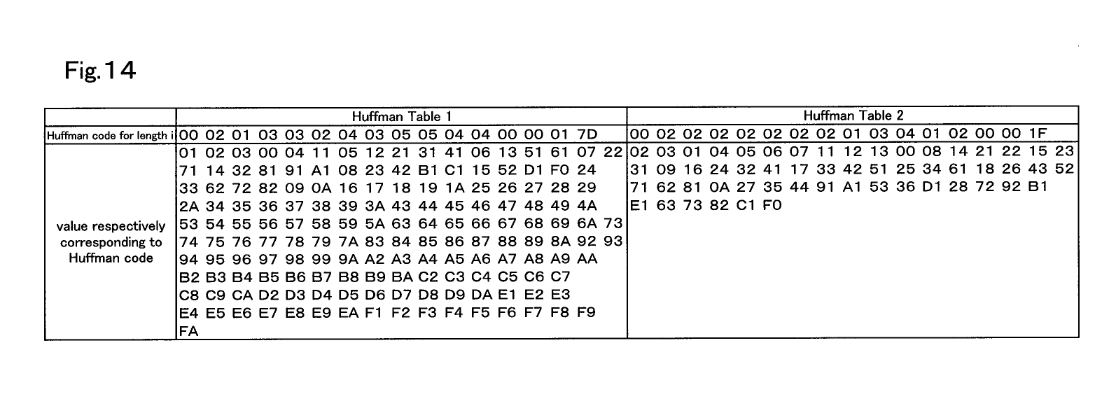

Next, a Huffman table is selected using the calculated entropy. Specifically, as shown in FIG. 14, there are two categories, of Huffman table 1 and Huffman table 2, and either Huffman table is selected on the basis of entropy calculated with equation 1.

Here, the Huffman table 1 is used in the event that correlation in adjacent pixel output is strong, as with a natural image. On the other hand, the Huffman table 2 is a table used in the event that pixel output varies steeply, as with an artificial image like a so-called snowstorm on a television screen, or an image that has been taken of fine lace with a black background.

If Huffman table selection is completed, then next processing returns to FIG. 6 and compression parameters are output to the JPEG processing section 53 (S37). Here, the compression parameters are the quantization parameter obtained in step S33 and the Huffman table selected in step S35.

If output of compression parameters is completed (S37), then next processing returns to FIG. 3 and transfers to image processing of step S7 (refer to FIG. 3). The flow of this image processing will be described using FIG. 9. In the image processing section 51, first of all correction processing is carried out for the image data (S61). As correction processing, processing for white balance and optical black etc. is carried out.

Synchronization processing is then carried out (S63). The image sensor 3 has RGB fundamental color filters arranged in a Bayer array, and so RGB values for each pixel are obtained by interpolation.

If the synchronization processing is completed, image correction is then carried out (S65). As image correction, correction such as color reproducibility and gradation expression for image data is carried out. If image correction is completed, it is followed by YC conversion so as to give a YC signal comprised of brightness and color information (S67). Processing in the steps up to this point is performing of processing for RGB pixel output based on a Bayer array, but here JPEG compression and conversion is carried out to YC data that can be easily displayed on an LCD 47.

If the YC conversion of step S67 is completed, returning to FIG. 3 the JPEG processing of step S9 is transferred to. The flow of this JPEG processing will be described using FIG. 10. At the JPEG processing section 53, first of all compression parameters are input (S71). As previously described, the compression parameters, made up of the quantization parameter and the selected Huffman table, are output in step S37 of the flow of FIG. 6.

Next, JPEG encoding is carried out using the input compression parameter (S73). Here, a new quantization table is generated from a quantization parameter N based on equation 4, and DCT coefficient quantization is carried out using this newly created quantization table. Next, compression data of a target code amount is output by subjecting the quantized DCT coefficients to Huffman coding based on the selected Huffman table.

The above described RAW compression processing and JPEG compression processing are implemented in hardware using the blocks shown in FIG. 2, but they can also be handled in software, using the CPU of the system controller 20 etc.

As has been described above, in this embodiment it is possible to predict the size of JPEG encoded data that is stored together with RAW data, and it is possible to increase the speed of storing JPEG data. Specifically, since it is possible to predict the JPEG code size before compression, a quantization parameter that gives a stipulated size can be set. Since the JPEG compression processing is not repeated until a stipulated size is finally reached, as with the related art, it is possible to speed up the storing of JPEG data.

With this embodiment, the JPEG format has been described as the lossy compression processing for image data, but other lossy compression systems can be adopted. Also, Huffman encoding has been used in the compression processing but this is not limiting, and it is possible to use other entropy encoding.

Further, in this embodiment, in predicting the size of JPEG data approximations have been attained using equation 1 and equation 2, as shown in FIG. 11 and FIG. 12, but the approximations are not limiting and it is possible to use various methods. Also, the approximations are not limiting and it is possible to create a table and obtain JPEG data size by interpolation calculation from this table, etc. Also with this embodiment, information entropy has been used as feature data representing frequency of appearance of high frequency components, but this is not limiting and it is also possible to use, for example, values representing dispersion.

Further, with this embodiment, using frequency of appearance has been utilized as compression data, but this is not limiting and is possible to use, for example, size of the variable length encoded data (S25 of FIG. 5) in the RAW compression processing section, and in this case, instead of the correlation between entropy and data size shown in FIG. 11 and FIG. 12, JPEG code size is predicted based on correlation between the variable length encoded data size and the JPEG code size.

The present invention is not limited to a digital single lens reflex camera, and can also be applied, for example, to a digital camera such as a compact digital camera, and can also be applied to a camera built into a mobile telephone or mobile information terminal (PDA: Personal Digital Assistant), and further, it goes without saying that the present invention can also be applied to a camera capable of being attached to a dedicated device, such as a photo booth for a microscope. In any event, the present invention can be applied to a camera, an electronic image taking device, or an image processing unit for executing image data compression.

What is claimed is:

1. An image data compression device, comprising:
an image processing section for detecting high frequency components of image data;
a calculation section for calculating feature data representing distribution of appearance frequency of the high frequency components;
a compression processing section for carrying out compression processing of the image data based on a quantization table and a Huffman encoding table;
a code amount predicting section for calculating, based on the feature data, predictive coding amount when the image data has been compressed by the compression processing section on the basis of a first quantization table;
a quantization table generating section, for calculating a second quantization table for obtaining target code amounts that it is desired to finally acquire in the compression section, based on the target code amount and the predictive coding amount; and
a JPEG compression section for carrying out JPEG compression processing based on the second quantization table.

2. The image data compression device of claim 1, wherein:
in the image processing section, the high frequency components are difference values of image data between adjacent pixels.

3. The image data compression device of claim 1, wherein:
when a parameter representing size of a high frequency component is made i, and appearance frequency corresponding to the parameter i is made Pi, the feature data calculated by the calculating sections is represented as −ΣPi·Log Pi.

4. The image data compression device of claim 1, wherein:
if the feature data is made Eraw, predictive coding amount when the JPEG compression processing has been carried out based on the first quantization table is made Djpeg, and A, B, C, D and E are respective constants, the correlations
Djpeg=A×Eraw+B
or
Djpeg=C×Eraw2+D×Eraw+E
hold.

5. The image data compression device of claim 1, wherein:
if predictive coding amount when JPEG compression processing is carried out on the basis of the first quantization table is Djpeg, a quantization parameter is N, F and G are constants, and a target code amount when the JPEG compression processing is carried out on the basis of the quantization parameter N is Dtarget,
Dtarget is represented as Djpeg×(F×2^{-N}+G) and
if the first quantization table is made Q1, the second quantization table is made Q2, and N is a quantization parameter,
Q2 is represented as Q1×2^{-N}.

6. The image data compression device of claim 1, further comprising a variable length coding section for carrying out coding of RAW data and generating variable length code data

7. An image data compression method, comprising:
detecting high frequency components of image data;
calculating feature data representing distribution of appearance frequency of the high frequency components;
calculating, based on the feature data, predictive coding amount when the image data has been compressed by a compression processing section on the basis of a first quantization table;
calculating a second quantization table for obtaining target code amount it is desired to finally acquire in the compression section, based on the target code amount and the predictive coding amount; and
carrying out JPEG compression processing based on the second quantization table.

8. A storage medium, storing an image data compression program executed on a computer, comprising:
detecting high frequency components of image data;
calculating feature data representing distribution of appearance frequency of the high frequency components;
calculating, based on the feature data, predictive coding amount when the image data has been compressed by a compression processing section on the basis of a first quantization table;
calculating a second quantization table for obtaining target code amount it is desired to finally acquire in the compression section, based on the target code amount and the predictive coding amount; and
carrying out JPEG compression processing based on the second quantization table.

9. An image data compression device, comprising:
a RAW compression processing section for carrying out compression of image data by variable length coding based on difference values between image data of adjacent pixels, and obtaining compression information relating to image compression;
a JPEG parameter setting section for setting a quantization parameter for carrying out quantization for achieving a target data size based on the compression information, and a Huffman table for Huffman encoding data that has been quantized using the quantization parameter; and
a JPEG processing section for carrying out JPEG processing for the image data on the basis of the quantization parameter and the Huffman table.

10. The image data compression device of claim 9, wherein:
the compression information is entropy calculated based on appearance frequency values for the difference values.

11. An image data compression device, comprising:
a RAW compression processing section for subjecting image data to lossless compression, and obtaining compression information relating to the mage compression;
a lossy compression processing section for subjecting the image data to lossy compression; and
a parameter calculation section for obtaining a parameter that will achieve a target data size based on the compression information, wherein
the lossy compression processing section carries out lossy compression processing based on the parameter.

12. The image data compression device of claim 11, wherein:
entropy is calculated based on the compression information, and the parameter for achieving a target data size is obtained from correlation between this entropy and a data size using the lossy compression processing.

13. The image data compression device of claim 11, wherein:
the entropy is data that has been calculated based on appearance frequency values for high frequency components of the image data.

14. An image data compression method, comprising the steps of:
carrying out compression of image data by variable length encoding based on difference values between image data of adjacent pixels, and obtaining compression information relating to image compression;
setting a quantization parameter for carrying out quantization for achieving a target data size based on the compression information, and a Huffman table for Huffman encoding data that has been quantized using the quantization parameter; and
carrying out JPEG compression processing for the image data on the basis of the quantization parameter and the Huffman table.
